(19) United States
(12) Patent Application Publication
(10) Pub. No.: US 2025/0277540 A1
(43) Pub. Date: Sep. 4, 2025

(54) SOLENOID VALVE POPPET AFFIXMENT

(71) Applicant: ASCO, L.P., Florham Park, NJ (US)

(72) Inventors: James R. Ward, Sturgis, MI (US); Alexander R. Determan, Grand Blanc, MI (US); Matthew Tyler Hoskins, Oak Park, MI (US); Rakeshkumar Krishnat Patil, Pune (IN); Niles Hanmant Sapate, Pune (IN)

(73) Assignee: ASCO, L.P., Florham Park, NJ (US)

(21) Appl. No.: 19/066,116

(22) Filed: Feb. 27, 2025

(30) Foreign Application Priority Data
Feb. 29, 2024 (IN) 202421014854

(51) Int. Cl. F16K 31/06; F16K 1/36; F16K 1/42; F16K 11/044

(52) U.S. Cl. CPC F16K 31/0627; F16K 1/36; F16K 1/42; F16K 11/044

(57) ABSTRACT

A valve can include a valve body having a port section and a coil support section extending along a longitudinal axis, a plunger within the valve body and extending at least partially through the coil support section, and a poppet configured to selectively engage a valve seat to open and close a flow path through the port section of the valve body. The plunger can include a stem extending into the port section of the valve body. The stem can include a plurality of annular barbs. The barbs can engage an interior of the poppet to hold the poppet in place on the stem.

### CROSS-REFERENCE TO RELATED APPLICATIONS

This application claims priority to Indian Patent Application number 202421014854 filed Feb. 29, 2024, the contents of which are incorporated herein by reference. This application is related to commonly owned U.S. patent application Ser. Nos. 18/590,943, 18/590,944, 18/590,945 and 18/590,946, each filed on Feb. 29, 2024, and the contents of which are incorporated herein by reference.

### BACKGROUND OF THE INVENTION

Field of the Invention The present disclosure relates generally to solenoid valves and more specifically relates to miniature solenoid valves.

### DESCRIPTION OF THE RELATED ART

Solenoid valves commonly have poppets to selectively engage valve seats to open and close flow paths therethrough. Currently, such poppets are often manufactured using complex over molding techniques, which can be tedious and time consuming, where alignment can be critical. Such problems often cause quality control issues. As solenoid valves get smaller, these issues are compounded.

### SUMMARY OF THE INVENTION

Applicants have created new and useful devices, systems and methods for solenoid valves. In at least one embodiment, a valve can include a valve body having a port section and a coil support section extending along a longitudinal axis, a plunger within the valve body and extending at least partially through the coil support section, a poppet press-fit onto the plunger and configured to selectively open and close at least one flow path through the port section of the valve body, or any combination thereof. In at least one embodiment, the plunger can include a stem extending into the port section of the valve body. In at least one embodiment, the poppet can be press-fit onto the stem. In at least one embodiment, the stem can include one or more annular barbs to engage an interior of the poppet to hold the poppet in place on the stem. In at least one embodiment, the poppet can be configured to selectively engage a valve seat to selectively open and close the flow path through the port section of the valve body.

In at least one embodiment, the poppet can be rigid and/or configured to selectively engage a resilient valve seat to selectively open and close the flow path through the port section of the valve body. In at least one embodiment, the poppet can include a rigid portion configured to engage the barb on the stem and/or a resilient portion configured to selectively engage a valve seat to selectively open and close the flow path through the port section of the valve body. In at least one embodiment, the rigid portion can be harder than the resilient portion. In at least one embodiment, the rigid portion can include an annular flange. In at least one embodiment, the resilient portion can mate with the flange.

In at least one embodiment, the poppet can include a band around a perimeter of the poppet to secure the poppet to the stem. In at least one embodiment, the band can be crimped onto the poppet, thereby securing the poppet to the stem.

In at least one embodiment, the valve seat can be integral with the valve body. In at least one embodiment, the valve seat can be integral with a cap press-fit into one end of the valve body. In at least one embodiment, the poppet can include a seal configured to selectively engage a valve seat to selectively open and close the flow path through the port section of the valve body. In at least one embodiment, the poppet can include a first seal configured to selectively engage a first valve seat to selectively open and close a normally closed flow path through the port section of the valve body. In at least one embodiment, the poppet can include a second seal configured to selectively engage a second valve seat to selectively open and close a normally open flow path through the port section of the valve body.

In at least one embodiment, a valve can include a valve body having a port section and a coil support section extending along a longitudinal axis, a plunger within the valve body and extending at least partially through the coil support section, a poppet including a resilient portion configured to selectively engage a rigid valve seat to open and close at least one flow path through the port section of the valve body, or any combination thereof. In at least one embodiment, the plunger can include a stem extending into the port section of the valve body. In at least one embodiment, the stem can include at least one annular barb configured to engage an interior of the poppet to hold the poppet in place on the stem. In at least one embodiment, the valve seat can be integral with the valve body. In at least one embodiment, the valve seat can be integral with a cap press-fit into one end of the valve body.

In at least one embodiment, the poppet can include a rigid portion configured to engage the barb on the stem. In at least one embodiment, the rigid portion can be harder than the resilient portion. In at least one embodiment, the rigid portion can include an annular flange. In at least one embodiment, the resilient portion can mate with the flange.

In at least one embodiment, a valve can include a valve body having a port section and a coil support section extending along a longitudinal axis, a plunger within the valve body and extending at least partially through the coil support section, a poppet configured to selectively engage a valve seat to open and close a flow path through the port section of the valve body, or any combination thereof. In at least one embodiment, the plunger can include a stem extending into the port section of the valve body. In at least one embodiment, the stem can include a plurality of annular barbs. In at least one embodiment, the barbs can engage an interior of the poppet to hold the poppet in place on the stem.

### BRIEF DESCRIPTION OF THE DRAWINGS

FIG. 1 is a cross sectional view of one of many embodiments of a solenoid valve according to the disclosure.

FIG. 2 is a cross sectional view of a portion of one of many embodiments of a solenoid valve according to the disclosure.

FIG. 3 is a cross sectional view of a portion of another one of many embodiments of a solenoid valve according to the disclosure.

FIG. 4 is a cross sectional perspective view of one of many embodiments of a poppet according to the disclosure.

FIG. 5 is a cross sectional view of a portion of yet another one of many embodiments of a solenoid valve according to the disclosure.

FIG. 6 is a cross sectional perspective view of another one of many embodiments of a poppet according to the disclosure.

FIG. 7 is a cross sectional perspective view of a portion of the poppet of FIG. 6.

FIG. 8 is a cross sectional view of a portion of still another of many embodiments of a solenoid valve according to the disclosure.

FIG. 9 is an exploded cross sectional view of a portion of one of many embodiments of a poppet according to the disclosure.

FIG. 10 is a cross sectional view of a portion of one of many embodiments of a solenoid valve according to the disclosure.

FIG. 11 is a cross sectional view of another portion of one of many embodiments of a solenoid valve according to the disclosure.

FIG. 12 is a perspective view of one of many embodiments of a cap according to the disclosure.

FIG. 13 is an elevation view of one of many embodiments of a stop according to the disclosure.

FIG. 14 is a perspective view of the stop of FIG. 13.

FIG. 15 is an elevation view of another one of many embodiments of a stop according to the disclosure.

FIG. 16 is a cross sectional view illustrating one of many embodiments of an assembly method according to the disclosure, prior to the poppet being pressed onto the plunger.

FIG. 17 is a cross sectional view illustrating another of many embodiments of an assembly method according to the disclosure, showing the poppet pressed onto the plunger.

FIG. 18 is a cross sectional view illustrating yet another of many embodiments of an assembly method according to the disclosure, prior to the cap being pressed into the valve body.

FIG. 19 is a cross sectional view illustrating still another of many embodiments of an assembly method according to the disclosure, showing the cap pressed into the valve body.

FIG. 20 is a pneumatic diagram of one of many embodiments of an assembly system according to the disclosure.

### DETAILED DESCRIPTION OF THE INVENTION

The figures described above and the written description of specific structures and functions below are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms.

The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the figures and are not intended to limit the scope of the inventions or the appended claims. The terms “including” and “such as” are illustrative and not limitative. The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally. Further, all parts and components of the disclosure that are capable of being physically embodied inherently include imaginary and real characteristics regardless of whether such characteristics are expressly described herein, including but not limited to characteristics such as axes, ends, inner and outer surfaces, interior spaces, tops, bottoms, sides, boundaries, dimensions (e.g., height, length, width, thickness), mass, weight, volume and density, among others.

Any process flowcharts discussed herein illustrate the operation of possible implementations of systems, methods, and computer program products according to various embodiments of the present disclosure. In this regard, each block in a flowchart may represent a module, segment, or portion of code, which can comprise one or more executable instructions for implementing the specified logical function(s). It should also be noted that, in some implementations, the function(s) noted in the block(s) might occur out of the order depicted in the figures. For example, blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Applicants have created new and useful devices, systems and methods for solenoid valves. By press-fitting a poppet onto a plunger, press-fitting a cap into a valve body, press-fitting a stop into a valve body, or any combination thereof, manufacturing of the valve can be simplified, parts can be eliminated, costs can be reduced, operational adjustments can be made, and/or stacked tolerances can be reduced or eliminated.

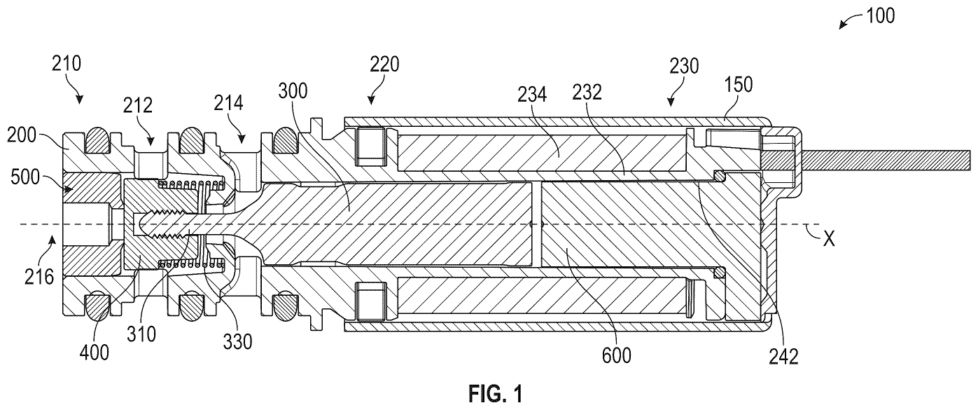

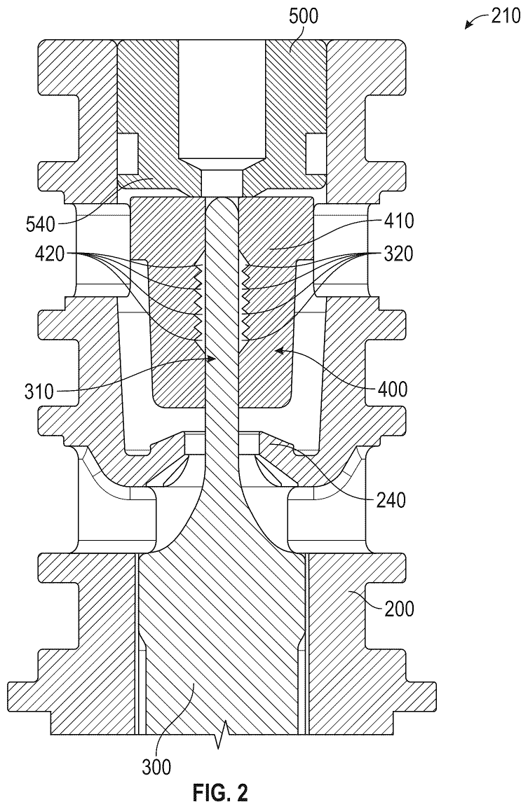

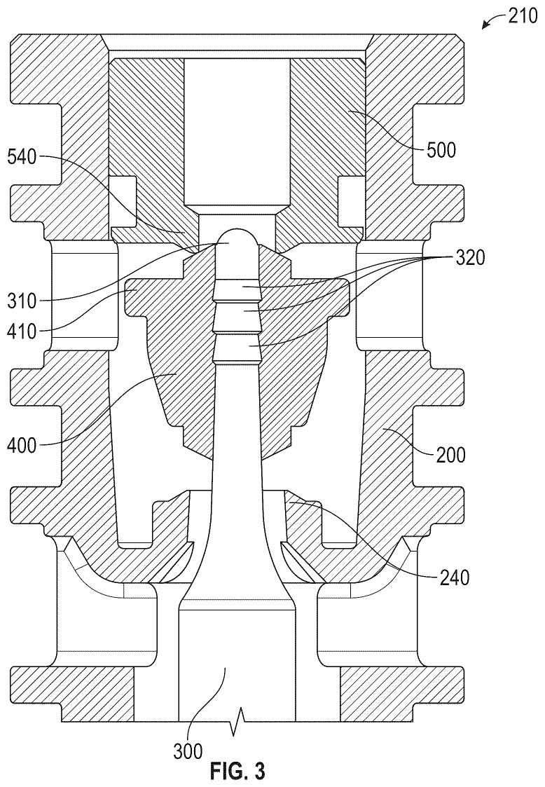

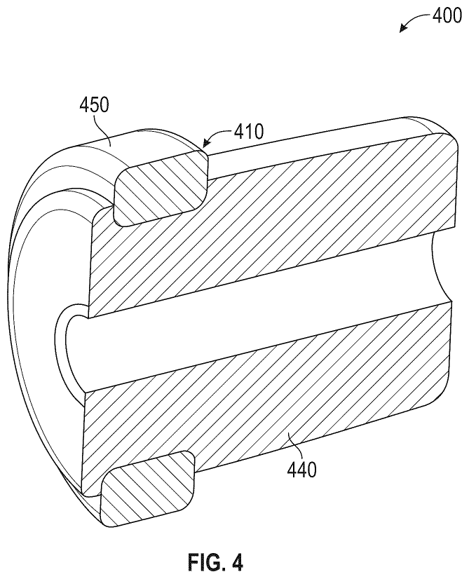

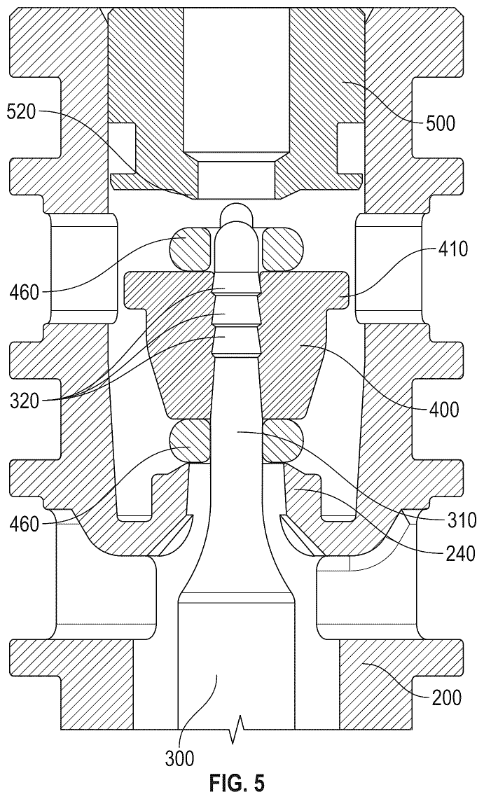

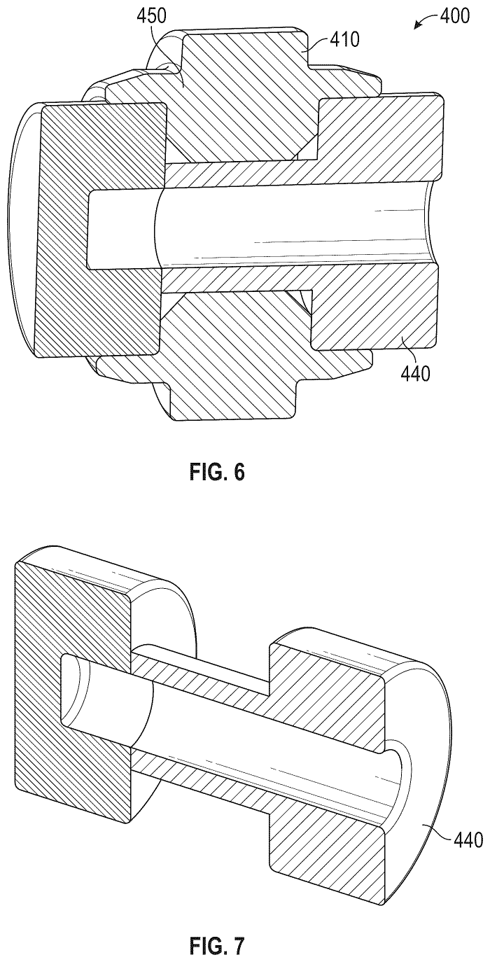

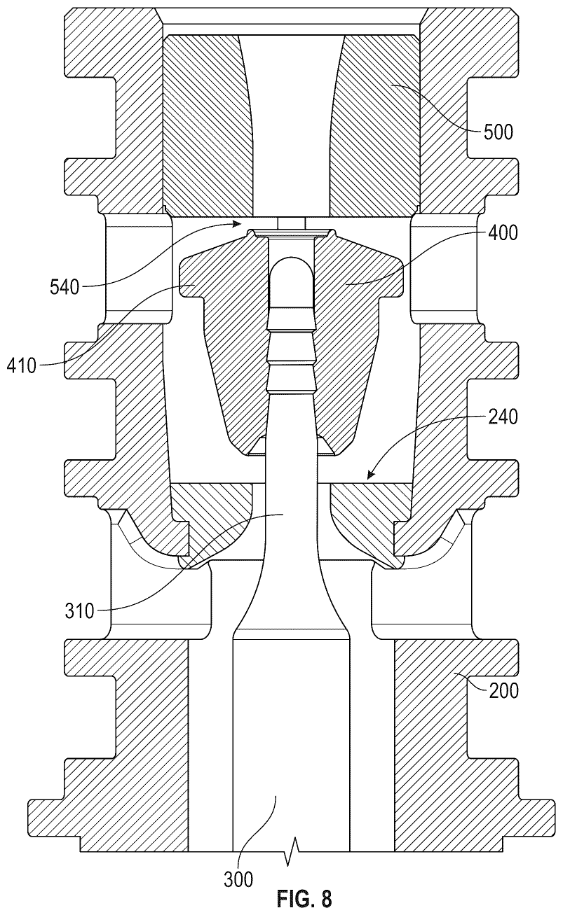

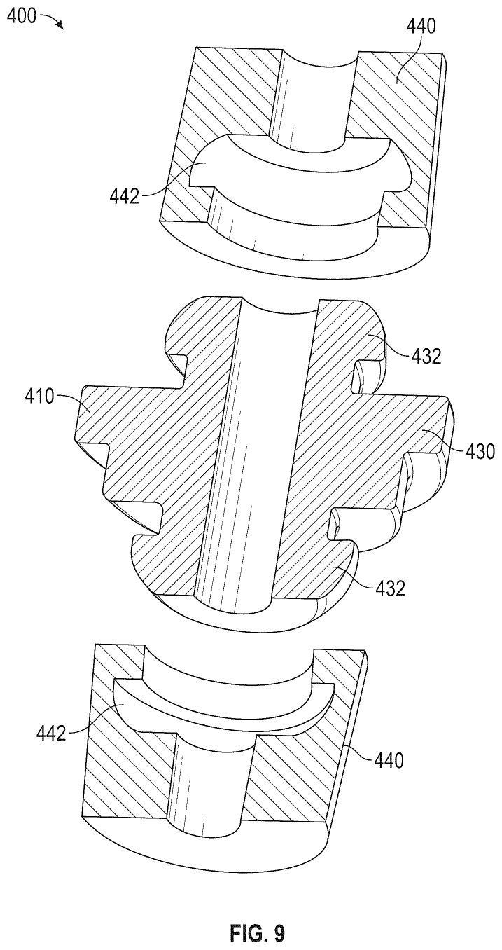

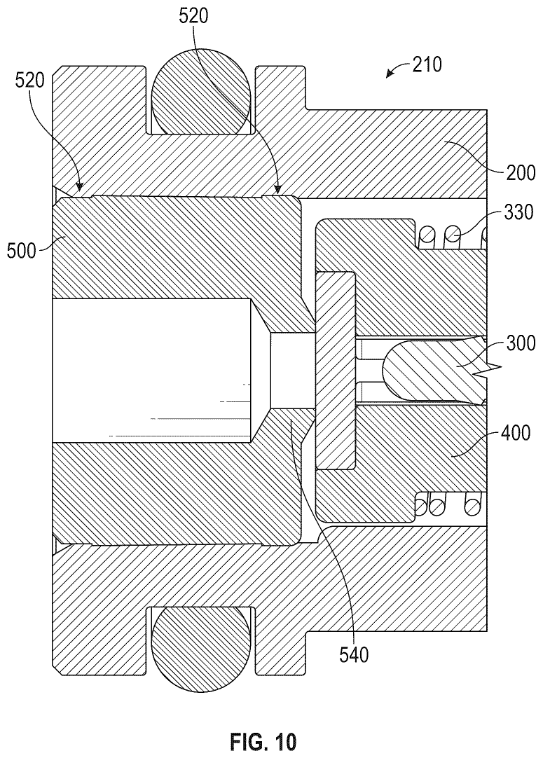

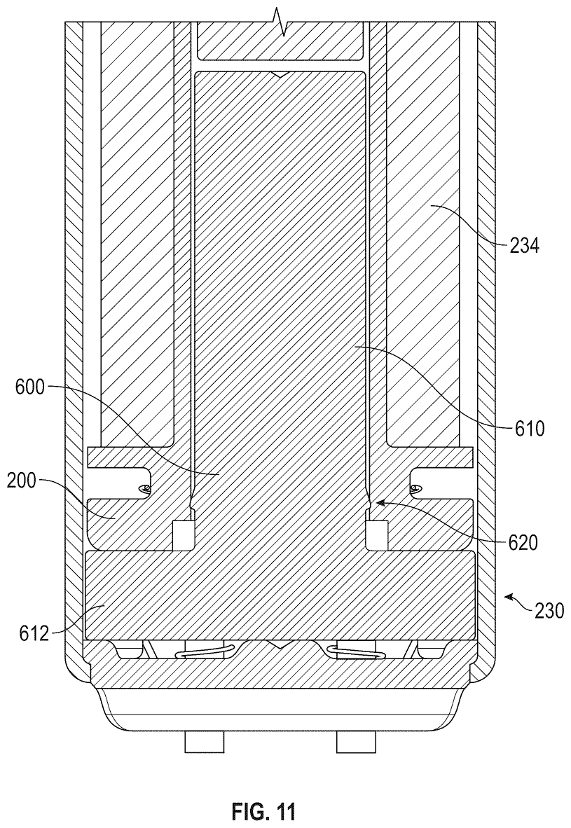

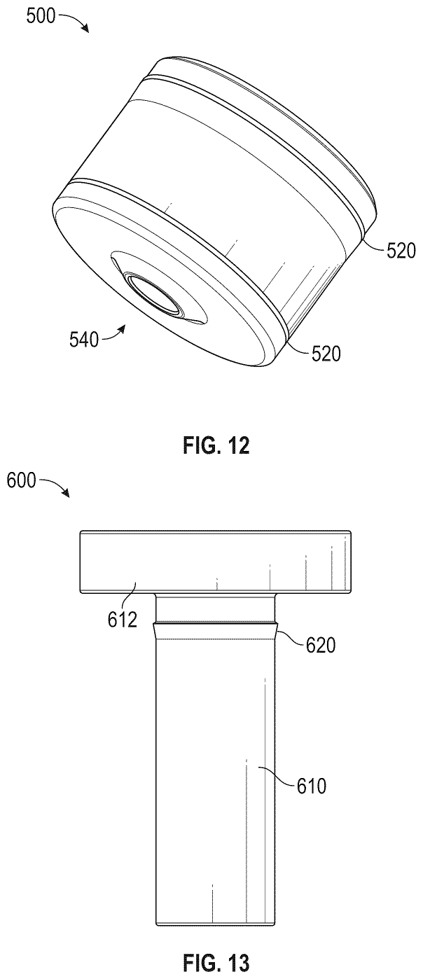

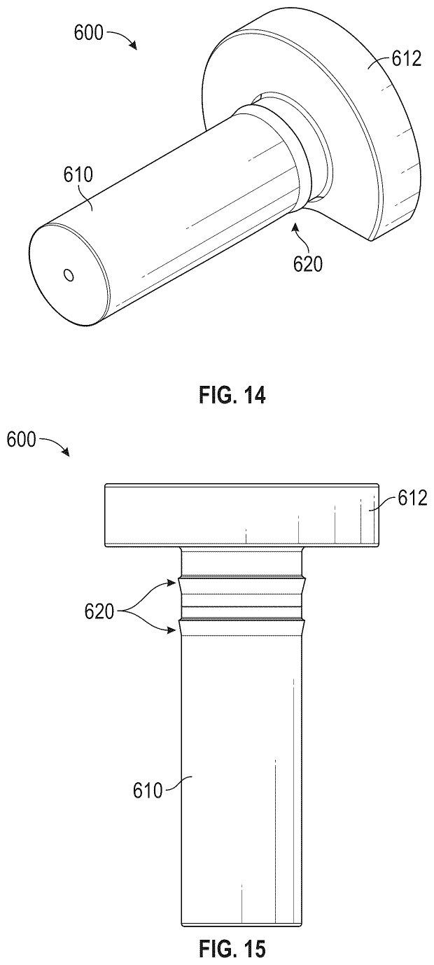

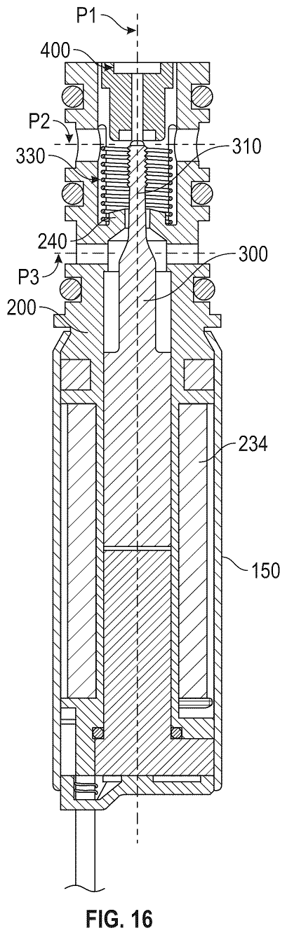

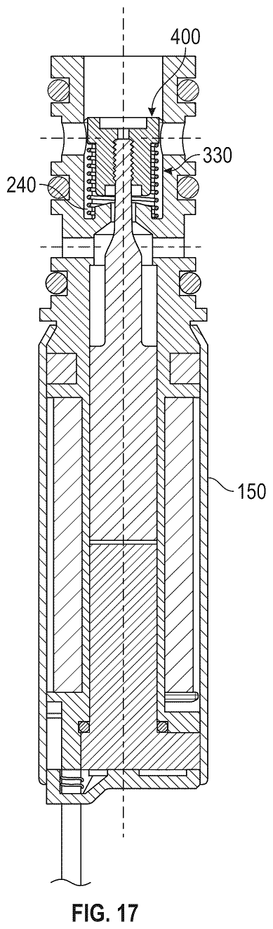

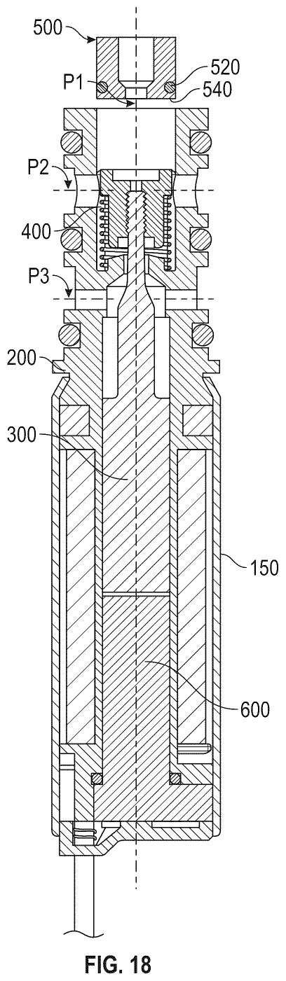

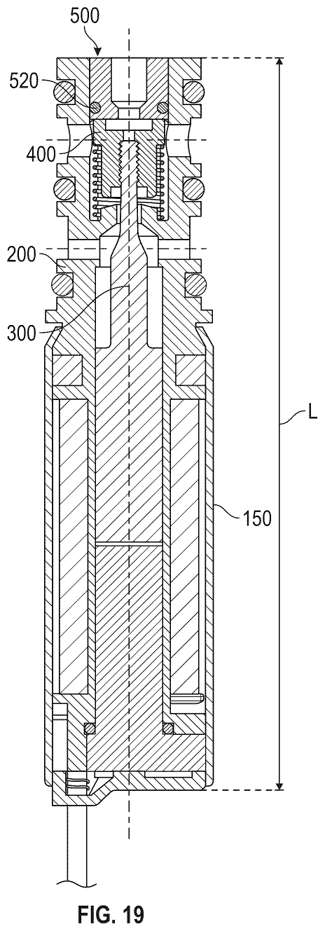

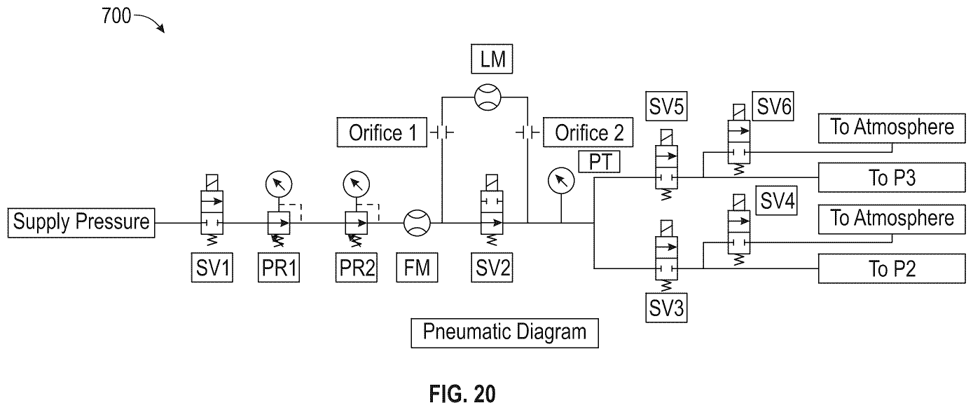

FIG. 1 is a cross sectional view of one of many embodiments of a solenoid valve according to the disclosure. FIG. 2 is a cross sectional view of a portion of one of many embodiments of a solenoid valve according to the disclosure. FIG. 3 is a cross sectional view of a portion of another one of many embodiments of a solenoid valve according to the disclosure. FIG. 4 is a cross sectional perspective view of one of many embodiments of a poppet according to the disclosure. FIG. 5 is a cross sectional view of a portion of yet another one of many embodiments of a solenoid valve according to the disclosure. FIG. 6 is a cross sectional perspective view of another one of many embodiments of a poppet according to the disclosure. FIG. 7 is a cross sectional perspective view of a portion of the poppet of FIG. 6. FIG. 8 is a cross sectional view of a portion of still another of many embodiments of a solenoid valve according to the disclosure. FIG. 9 is an exploded cross sectional view of a portion of one of many embodiments of a poppet according to the disclosure. FIG. 10 is a cross sectional view of a portion of one of many embodiments of a solenoid valve according to the disclosure. FIG. 11 is a cross sectional view of another portion of one of many embodiments of a solenoid valve according to the disclosure. FIG. 12 is a perspective view of one of many embodiments of a cap according to the disclosure. FIG. 13 is an elevation view of one of many embodiments of a stop according to the disclosure. FIG. 14 is a perspective view of the stop of FIG. 13. FIG. 15 is an elevation view of another one of many embodiments of a stop according to the disclosure. FIG. 16 is a cross sectional view illustrating one of many embodiments of an assembly method according to the disclosure, prior to the poppet being pressed onto the plunger. FIG. 17 is a cross sectional view illustrating another of many embodiments of an assembly method according to the disclosure, showing the poppet pressed onto the plunger. FIG. 18 is a cross sectional view illustrating yet another of many embodiments of an assembly method according to the disclosure, prior to the cap being pressed into the valve body. FIG. 19 is a cross sectional view illustrating still another of many embodiments of an assembly method according to the disclosure, showing the cap pressed into the valve body. FIG. 20 is a pneumatic diagram of one of many embodiments of an assembly system according to the disclosure. FIGS. 1-20 are described in conjunction with one another.

In at least one embodiment, a valve 100 according to the disclosure, such as a miniature solenoid valve, can include one or more valve bodies 200, one or more plungers 300 disposed at least partially within the valve body 200, one or more poppets 400 coupled to the plunger 300, one or more end caps 500 coupled at least partially within the valve body 200, one or more stops 600 coupled at least partially within the valve body 200, or any combination thereof. In at least one embodiment, a valve 100 can include a shell 150 for housing or protecting one or more other components of the valve. In at least one embodiment, the poppet 400 can be press-fit onto the plunger 300. In at least one embodiment, the cap 500 and/or the stop 600 can limit movement of the plunger 300 and/or poppet 400. In at least one embodiment, the cap 500 and/or the stop 600 can be press-fit into the valve body 200.

In at least one embodiment, the valve body 200 can include one or more port sections 210, one or more flux collar support sections 220, one or more coil support sections 230, or any combination thereof, extending along one or more axes, such as a central longitudinal axis X. In at least one embodiment, the port section 210 can include one or more common ports 212, one or more normally open ports 214, and one or more normally closed ports 216, or any combination thereof. In at least one embodiment, the flux collar support section 220 can support a flux collar, such as to improve efficiency of the valve 100. In at least one embodiment, the port section 210, the flux collar support section 220, and the coil support section 230 of the valve body 200 can be a unitary or monolithic structure, such as by way of being portions of an integrally formed structure (e.g., an injection molded structure).

In at least one embodiment, the plunger 300 can extend at least partially through the flux collar support section 220 and the coil support section 230. In at least one embodiment, the plunger 300 can extend at least partially through a flux collar supported by the flux collar support section 220. In at least one embodiment, the plunger 300 can include one or more stems 310 that extend into the port section 210. In at least one embodiment, the plunger 300 can include one or more poppets 400 mounted to the stem 310. In at least one embodiment, one or more biasing members 330, such as a spring, can bias the plunger 300 and/or poppet 400 towards or away from one or more caps 500.

In at least one embodiment, the coil support section 230 of the valve body 200 can include one or more annular walls 232 and/or one or more coils 234. In at least one embodiment, the wall 232 can support coil 234, which can selectively actuate, or move, the plunger 300 against the force of the spring 330, to thereby switch the valve 100 from a normally open position to a normally closed position. In at least one embodiment, the coil support section 230 can include one or more stops 600, such as a core and/or related structure, to limit the movement of the plunger 300 in one or more directions within the bore 242. In at least one embodiment, the stop 600 can be a single, unitary structure. In at least one embodiment, the stop 600 can be or include a plurality of structures.

In at least one embodiment, a valve 100 according to the disclosure can include one or more a poppets 400 press-fit onto the plunger 300 and configured to selectively open and close at least one flow path through the port section 210 of the valve body 200. In at least one embodiment, the plunger 300 can include a stem 310 extending into the port section 210 of the valve body 200. In at least one embodiment, the poppet 400 can include one or more shoulders 410 against which the spring 330 can rest and thereby bias the poppet 400 towards a normal operating position, opening a normally open flow path and/or closing a normally closed flow path through the valve body 210. In at least one embodiment, the coil 234 can overcome the spring 330 to move the plunger 300 and poppet 400 to close a normally open flow path and/or open a normally closed flow path through the valve body 210.

In at least one embodiment, the poppet 400 can be press-fit onto the stem 310. In at least one embodiment, the stem 310 can include one or more annular barbs 320 configured to engage an interior of the poppet 400 to hold the poppet 400 in place on the stem 310. In at least one embodiment, the stem 310 can include one annular barb 320 configured to engage an interior of the poppet 400 to hold the poppet 400 in place on the stem 310. In at least one embodiment, the stem 310 can include a plurality of annular barbs 320 configured to engage an interior of the poppet 400 to hold the poppet 400 in place on the stem 310.

In at least one embodiment, the poppet 400 can include one or more annular grooves 420 configured to engage the barbs(s) 320 on the stem 310 to hold the poppet 400 in place on the stem 310. In at least one embodiment, the poppet 400 can include one annular groove 420 configured to engage the barbs(s) 320 on the stem 310 to hold the poppet 400 in place on the stem 310. In at least one embodiment, the poppet 400 can include a plurality of annular grooves 420 configured to engage the barbs(s) 320 on the stem 310 to hold the poppet 400 in place on the stem 310. In at least one embodiment, the annular barb(s) 320 and/or the annular groove(s) 420 allow a position of the poppet 400 with respect to the stem 310 to be adjusted, such that the poppet 400 can be mounted along a range of positions along the stem 310.

In at least one embodiment, the poppet 400 can be unitary or made of multiple portions. In at least one embodiment, the poppet 400 can include a more rigid portion 430 configured to engage the barb 320 on the stem 310. In at least one embodiment, the poppet 400 can include a more a resilient portion configured to selectively engage one or more valve seats 240, 540 to selectively open and close the flow path through the port section 210 of the valve body 200. In at least one embodiment, with the rigid portion 430 being harder, or more rigid, than the resilient portion 440, the rigid portion 430 can better hold the poppet 400 in place along the stem 310 of the plunger 300. In at least one embodiment, with the resilient portion 440 being more resilient, softer, and/or more elastomeric than the rigid portion 430, the resilient portion 440 can better seal with the valve seats 240, 540. In at least one embodiment, the resilient portion 440 can be pulled at least partially into, thru, or onto the rigid portion 430. In at least one embodiment, the rigid portion 430 can include one or more annular flanges 432. In at least one embodiment, the resilient portion 440 can include one or more slots 442 configured to mate with the flange 432.

In at least one embodiment, the poppet 400 can include one or more bands 450 around a perimeter of the poppet 400 to secure the poppet 400 to the stem 310. In at least one embodiment, the poppet 400 can be pulled at least partially into, or thru, the band 450. In at least one embodiment, the band 450 can be metal and/or crimped onto the poppet 400, thereby securing the poppet 400 to the stem 310. In at least one embodiment, the band 450 can be a more rigid polymer than the poppet 400, or the resilient portion 440 thereof, thereby supporting and/or securing the poppet 400 to the stem 310.

In at least one embodiment, the poppet 400 can selectively engage one or more valve seats 240, 540 to selectively open and close one or more flow paths through the port section 210 of the valve body 200. In at least one embodiment, one or more valve seats 240 can be integral with the valve body 200 and/or can be part of a normally open or normally closed flow path. In at least one embodiment, one or more valve seats 540 can be integral with a cap 500 press-fit into one end of the valve body 200.

In at least one embodiment, the poppet 400 can include one or more seals 460, such as gasket(s) or O-ring(s), configured to selectively engage one or more valve seats 240, 540 to selectively open and close one or more flow path through the port section 210 of the valve body 200. In at least one embodiment, the poppet 400 can include a first seal 460 configured to selectively engage a first valve seat 540 to selectively open and close a normally closed flow path through the port section 210 of the valve body 200. In at least one embodiment, the poppet 400 can include a second seal 460 configured to selectively engage a second valve seat 240 to selectively open and close a normally open flow path through the port section 210 of the valve body 200. In at least one embodiment, the seal(s) 460 can be mounted to the poppet 400 and/or the stem 310, with the poppet 400 selectively pressing the seals(s) 460 into the valve seats 240, 540.

In at least one embodiment, portions of the valve body 200 and/or the cap 500 can be resilient. In at least one embodiment, all, or portions, of the poppet 400 can be rigid. In at least one embodiment, the poppet 400 can be rigid and configured to selectively engage a resilient valve seat 240, 540 to selectively open and close the flow path through the port section 210 of the valve body 200.

In at least one embodiment, a valve 100 according to the disclosure, such as a miniature solenoid valve, can include one or more valve bodies 200 having a port section 210 and a coil support section 230 extending along a longitudinal axis, one or more plungers 300 within the valve body 200 and extending at least partially through the coil support section 230, a poppet 400 including a resilient portion 440 configured to selectively engage a rigid valve seat 240, 540 to open and close at least one flow path through the port section 210 of the valve body 200, or any combination thereof. In at least one embodiment, the plunger 300 can include one or more stems 310 extending into the port section 210 of the valve body 200. In at least one embodiment, the stem 310 can include at least one annular barb 320 configured to engage an interior of the poppet 400 to hold the poppet 400 in place on the stem 310. In at least one embodiment, one or more of the valve seats 240 can be integral with the valve body 200. In at least one embodiment, one or more of the valve seats 540 can be integral with a cap 500 press-fit into one end of the valve body 200.

In at least one embodiment, the poppet 400 can include one or more rigid portions 430 configured to engage the barb 320 on the stem 310. In at least one embodiment, the rigid portion 430 can be harder than the resilient portion 440. In at least one embodiment, the rigid portion 430 can include one or more an annular flanges 432. In at least one embodiment, the resilient portion 440 can be configured to mate with the flange 432 and/or can include one or more slots 442 configured to mate with the flange 432.

In at least one embodiment, a valve 100 according to the disclosure, such as a miniature solenoid valve, can include one or more valve bodies 200 having a port section 210 and a coil support section 230 extending along a longitudinal axis, one or more plungers 300 within the valve body 200 and extending at least partially through the coil support section 230, one or more poppets 400 configured to selectively engage one or more valve seats 240, 540 to open and close one or more flow path through the port section 210 of the valve body 200, or any combination thereof. In at least one embodiment, the plunger 300 can include a stem 310 extending into the port section 210 of the valve body 200. In at least one embodiment, the stem 310 can include one or more annular barbs 320. In at least one embodiment, the barbs 320 can engage an interior of the poppet 400 to hold the poppet 400 in place on the stem 310.

By press-fitting the poppet 400 onto the stem 310 of the plunger 300, manufacturing of the valve 100 can be simplified, parts can be eliminated, costs can be reduced, operational adjustments can be made, and/or stacked tolerances can be reduced or eliminated. For example, a poppet body or holder can be eliminated. In at least one embodiment, the poppet 400 according to the disclosure does not require a complex and/or expensive over molding process. In at least one embodiment, the poppet 400 according to the disclosure can include a myriad of techniques, as described above, to provide adequate holding force, or resistance to pull-out, to remain in place on the plunger 300 for proper functionality within the valve 100. In at least one embodiment, the poppet 400 according to the disclosure can be a monolithic or unitary elastomeric, or otherwise resilient, structure with integral shoulder 410 for the spring 330 to provide a bias force against in order to operate the valve 100. In at least one embodiment, one or more of the barbs 320 and/or grooves 420 can be spiral, thereby allowing the poppet 400 according to the disclosure to be press-fit and/or threaded onto the stem 310, while still achieving many or all of the advantages discussed herein.

In at least one embodiment, an external surface of the stem 310 and/or an internal surface of the poppet 400 can be rough, or roughened, to increase static friction between the stem 310 and the poppet 400. In at least one embodiment, a dissolvable and/or evaporable lubricant can be used during assembly of the valve 100, such as to temporarily reduce friction between the stem 310 and the poppet 400. In at least one embodiment, an adhesive can be used to bond the stem 310 and the poppet 400. In at least one embodiment, the poppet 400 can include a through hole in order to inject an adhesive between the stem 310 and the poppet 400. In at least one embodiment, the poppet 400 can be designed to allow for transfer of heat or ultraviolet light to the adhesive between the stem 310 and the poppet 400. In at least one embodiment, the poppet 400 according to the disclosure can be vulcanized, hardened, shrunk, or any combination thereof once in place on the stem 310. In at least one embodiment, the poppet 400 according to the disclosure, or a portion thereof, can be metal and/or a rigid polymer and/or the valve seats 240, 540 can be metal and/or a rigid polymer, with the valve 100 relying on a metal-to-metal and/or metal-to-plastic seal, thereby eliminating elastomeric materials in sealing the flow path(s).

In at least one embodiment, a valve 100 according to the disclosure can include one or more caps 500 press-fit at least partially into the valve body 200 at an end of the valve body 200, such as at the port section 210 of the valve body. In at least one embodiment, the cap 500 can include one or more valve seats 540 that can be selectively engaged by the poppet 400 mounted to the plunger 300 to selectively open and close a flow path through the port section 210 of the valve body 200. In at least one embodiment, the cap 500 can include one or more annular barbs 520 that sealingly mate with the valve body 200. In at least one embodiment, the barb 520 can extend around a perimeter of the cap 500. In at least one embodiment, the barb 520 can resist pressure within the valve body 200 to hold the cap 500 in place within or relative to the valve body 500. In at least one embodiment, the annular barb(s) 520 can allow a position of the cap 500 within the valve body 200 to be adjusted, such that the cap 500 can be mounted along a range of positions along the valve body 200. Adjusting the position of the cap 500 within or relative to the valve body 200 can adjust the stroke of the plunger 300, one or more flow rates through the port section 210 of the valve body, reduce stacked tolerances in the valve 100, or any combination thereof.

In at least one embodiment, the barb 520 can be integral with the cap 500 and/or can hermetically or fluidically seal the cap 500 to the valve body 200, which can include doing so without any additional sealing device, such as an O-ring, gasket, or sealant. In at least one embodiment, the barb 520 and/or the cap 500 can be metal and/or the valve body 200 can be a resilient material. In at least one embodiment, the barb 520 can deform the valve body 200, such as while being press-fit therein, thereby sealing the cap 500 to the valve body 200.

In at least one embodiment, the cap 500 can include one annular barb 520 that extends around a perimeter of the cap 500. In at least one embodiment, the cap 500 can include two or more annular barbs 520 that extend around a perimeter of the cap 500. In at least one embodiment, the barbs 520 can resist pressure within the valve body 200 to hold the cap 500 in place within or relative to the valve body 200.

In at least one embodiment, a valve 100 according to the disclosure can include one or more stops 600 press-fit at least partially into the valve body 200 at an end of the valve body 200, such as at the coil section 230 of the valve body 200. In at least one embodiment, the stop 600 can include one or more shafts 610 to limit movement of the plunger 300 away from (i.e., in a direction away from) the cap 500 and/or a flange 612, which can fix a position of the stop 600 with respect to the valve body 200. In at least one embodiment, the stop 600 can include one or more annular barbs 620 that sealingly mates with the valve body 200. In at least one embodiment, the barb 620 can extend around a perimeter of the stop 600. In at least one embodiment, the barb 620 can extend around a perimeter of the shaft 610 and/or the flange 612. In at least one embodiment, the barb 620 can resist pressure within the valve body 200 to hold the stop 600 in place within or relative to the valve body 200. In at least one embodiment, the annular barb(s) 620 can allow a position of the stop 600 within or relative to the valve body 200 to be adjusted, such that the stop 600 can be mounted along a range of positions along the valve body 200. Adjusting the position of the stop 600 within or relative to the valve body 200 can adjust the stroke of the plunger 300, and/or reduce stacked tolerances in the valve 100.

In at least one embodiment, the barb 620 can be integral with the stop 600 and/or can hermetically or fluidically seal the stop 600 to the valve body 200, which can include doing so singlehandedly, such as without the aid of an additional sealing device, such as an O-ring, gasket, or sealant. In at least one embodiment, the barb 620 and/or the stop 600 can be metal and/or the valve body 200 can be a resilient material. In at least one embodiment, the barb 620 can be configured to deform the valve body 200, such as while being press-fit therein, thereby sealing the stop 600 to the valve body 200.

In at least one embodiment, the stop 600 can include one or more annular barbs 620 that extend around a perimeter of the stop 600. In at least one embodiment, the stop 600 can include two or more annular barbs 620 that extend around a perimeter of the stop 600. In at least one embodiment, the barbs 620 can resist pressure within the valve body 200 and/or can hold the stop 600 in place within or relative to the valve body 200.

In at least one embodiment, a valve 100 according to the disclosure can include one or more valve bodies 200 having a port section 210 and a coil support section 230 extending along a longitudinal axis, a plunger 300 within the valve body 200 and extending at least partially through the coil support section 230, a cap 500 press-fit at least partially into the valve body 200 at a first end of the valve body 200, a stop 600 press-fit at least partially into the valve body 200 at a second, opposite end of the valve body 200, or any combination thereof. In at least one embodiment, the cap 500 can include a valve seat 540 configured to be selectively engaged by a poppet 400 mounted to the plunger 300 to selectively open and close a flow path through the port section 210 of the valve body 200. In at least one embodiment, the cap 500 can include one or more first annular barbs 520 extending around a perimeter of the cap 500, which can sealingly secure the cap 500 at least partially within the valve body 200. In at least one embodiment, the stop 600 can limit movement of the plunger 300 away from the cap 500. In at least one embodiment, the stop 600 can include one or more second or other annular barbs 620 extending around a perimeter of the stop 600, which can sealingly secure the stop 600 at least partially within the valve body 200.

In at least one embodiment, the first barb 520 can resist pressure within the valve body 200 to hold the cap 500 in place within or relative to the valve body 200. In at least one embodiment, the first barb 520 can be metal. In at least one embodiment, the first barb 520 and the cap 520 can be integrally formed of metal. In at least one embodiment, the valve body 200 can be a resilient material. In at least one embodiment, the first barb 520 can deform the valve body 200, such as while being press-fit therein, thereby sealing the cap 500 to the valve body 200.

In at least one embodiment, the second barb 620 can resist pressure within the valve body 200 to hold the stop 600 in place within or relative to the valve body 200. In at least one embodiment, the barb can be metal. In at least one embodiment, the second barb and the stop can be integrally formed of metal. In at least one embodiment, the valve body can be a resilient material. In at least one embodiment, the second barb can deform the valve body, such as while being press-fit therein, thereby sealing the stop 600 to the valve body.

Utilizing barbs 520, 620 on the cap 500 and/or stop 600, any of which can be metallic, advantageously provides retention and/or hermetic sealing within the valve body 200, which can be plastic or polymer, that requires no additional parts to function, reduces the number of parts required, reduces time and/or effort required for assembly, allows for positional fixation and/or adjustment within the valve body 200, or any combination thereof. In at least one embodiment, the cap 500 can include two or more barbs 520 to prevent angular misalignment of the valve seat 540 to the valve body 200 and/or plunger 400. In at least one embodiment, heat can be used to shrink, stake, and/or further couple or seal the valve body 200 to the cap 500 and/or the stop 600.

In at least one embodiment, a valve 100 according to the disclosure can include one or more valve bodies 200 having a port section 210 and a coil support section 230 extending along a longitudinal axis, a plunger 300 within the valve body 200 and extending at least partially through the coil support section 230, a poppet 400 press-fit onto the plunger 300, or any combination thereof. In at least one embodiment, the body 200 can include one or more first valve seats 240. In at least one embodiment, the plunger 300 can include a stem 310 extending through the first valve 240 seat into the port section 210. In at least one embodiment, the poppet 400 can be press-fit onto the stem 310 of the plunger 400. In at least one embodiment, the poppet 400 can selectively engage the first valve seat 240 to open and close a first flow path through the port section 210 of the valve body 200. In at least one embodiment, a stroke of the plunger 300 and/or a flow rate through the first flow path can be adjusted by adjusting a first position of the poppet 400 on the plunger 300.

In at least one embodiment, a valve 100 according to the disclosure can include one or more caps 500 press-fit at least partially into the port section 210 of the valve body 200. In at least one embodiment, the cap 500 can include one or more second valve seat 540. In at least one embodiment, the poppet 400 can selectively engage the second valve seat 540 to open and close a second flow path through the port section 210 of the valve body 200. In at least one embodiment, a stroke of the plunger 300 and/or a flow rate through the second flow path can be adjusted by adjusting a second position of the cap 500 in or relative to the body 200.

In at least one embodiment, a method of assembling a valve 100 according to the disclosure can include monitoring a first flow between a first port and a second port of the valve 100 and/or pressing a poppet 400 onto a plunger 300 of the valve 100 until the first flow stops. In at least one embodiment, a method of assembling a valve 100 according to the disclosure can include monitoring a second fluid flow between the first port and a third port of the valve 100, energizing a coil 234 of the valve 100, pressing a cap 500 into a body 200 of the valve 100 until the second fluid flow stops, or any combination thereof. In at least one embodiment, a method of assembling a valve 100 according to the disclosure can include monitoring a second fluid flow between the first port and a third port of the valve 100 and/or pressing a cap 500 into a body 200 of the valve 100 until a desired rate of the second fluid flow is achieved. In at least one embodiment, the first port can be a common port. In at least one embodiment, the second port can be a normally closed port. In at least one embodiment, the third port can be a normally open port.

In at least one embodiment, an assembly system or apparatus 700, such as that shown in FIG. 20 for exemplary purposes, can be used to provide a controlled fluid flow to/from one or more ports of the port section 210 of the valve body 200 during assembly of valve 100. In at least one embodiment, such fluid flow can be of air, another inert gas, water, another inert fluid, or any combination thereof. In at least one embodiment, the system 700 can be or include a pneumatic system, one or more assembly fixtures (not shown) and one or more presses or pressing machines (not shown), such as a dynamic precision press capable of precision pressing of components based on closed loop sensor feedback. In at least one embodiment, the system 700 can one or more supply pressure inlets, one or more solenoid valves (e.g., solenoid valves SV1, SV2, et seq.), one or more pressure regulators (e.g., pressure regulators PR1, PR2), one or more flow meters (e.g., flow meter FM), one or more level meters (e.g., level meter LM), one or more pressure transmitters (e.g., pressure transmitter PT), one or more orifices, one or more valve port connections, one or more vents to atmosphere, or any combination thereof.

In at least one embodiment, a method of assembling a valve 100 according to the disclosure can include monitoring a power consumption of the coil 234 and continuing to press the cap 500 into the body 200 and/or the poppet 400 onto the plunger 300, until the power consumption matches a desired setpoint. By adjusting the position of the cap 500 in or relative to the body 200 and/or the poppet 400 on the plunger 300, power consumption of the coil 234 can be controlled.

In at least one embodiment, a method of assembling a valve 100 according to the disclosure can include energizing a coil 234 of the valve 100, de-energizing the coil 234 of the valve 100, and monitoring for a sound caused by a plunger 300 of the valve 100 contacting a stop 600 of the valve 100. In at least one embodiment, a method of assembling a valve 100 according to the disclosure can include repeating the steps of pressing the poppet 400 onto the plunger 300, energizing the coil 234 of the valve 100, de-energizing the coil 234 of the valve 100, monitoring for the sound caused by the plunger 300 contacting the stop 600, or any combination thereof, until the sound caused by the plunger 300 contacting the stop 600 is no longer detected. By adjusting the position of the poppet 400 on the plunger 300, the stroke of the plunger 300 can be controlled, such as to limit the engagement between the plunger 300 and the stop 600.

In at least one embodiment, a method of assembling a valve 100 according to the disclosure can include monitoring a first flow between a common port and a normally closed port of the valve 100, pressing a poppet 400 onto a plunger 300 of the valve 100 until the first flow stops, monitoring a second fluid flow between the common port and a normally open port of the valve 100, energizing a coil 234 of the valve 100, pressing a cap 500 into a body 200 of the valve 100 until the second fluid flow stops, or any combination thereof. In at least one embodiment, the method of assembling a valve 100 according to the disclosure can further include monitoring a power consumption of the coil 234 and/or continuing to press, or repeatedly pressing, the cap 500 into the body 200 and/or the poppet 400 onto the plunger 300, until the power consumption matches a desired setpoint. In at least one embodiment, the method of assembling a valve 100 according to the disclosure can further include energizing the coil 234 of the valve 100, de-energizing the coil 234 of the valve 100, monitoring for a sound caused by a plunger 300 of the valve 100 contacting a stop 600 of the valve 100, or any combination thereof. In at least one embodiment, the method of assembling a valve 100 according to the disclosure can further include repeating pressing the poppet 400 onto the plunger 300, energizing the coil 234 of the valve 100, de-energizing the coil 234 of the valve 100, monitoring for the sound caused by the plunger 300 contacting the stop 600, or any combination thereof, until the sound caused by the plunger 300 contacting the stop 600 is no longer detected. In at least one embodiment, the poppet 400 can be pressed onto the plunger 300 before the cap 500 is pressed into the body 200.

By monitoring flow rates through the port section 210 of the valve 100 while pressing the poppet 400 onto the plunger 300 and/or the cap 500 into the body 200 the position of the poppet 400 on the plunger 300 and/or the cap 500 in the body 200 can be adjusted, thereby reducing, eliminating, or otherwise mitigating the effects of stack-up tolerances in the valve 100, such as those impacting the stroke of the plunger 300. Pressing the poppet 400 further onto the plunger 300 and/or pressing the cap 500 further into the body 200 can adjust the stroke of the plunger 300, flow through the port section of the valve 100, power consumption of the coil 234, operational noise within the valve 100, load and/or preload on the spring 330, or any combination thereof. The assembly method described herein can reduce costs through increased tolerances (i.e., the adjustability reduces the effect of tolerances, thereby allowing for looser tolerances in individual component manufacturing) provide better performance by reducing excess elastomer deformation on the valve seats 240, 540, mitigate against energized leak by conducting a pressing operation until enough elastomer deformation has occurred to adequately seal between the cap 500 and the body 200 and/or between the stop 600 and the body 200, offer precise flow control, offer variability in flow rates without change to orifice size, increase reliability of the valve 100 (e.g., since functionality can be confirmed during assembly), or any combination thereof. Stack-up tolerances can be mitigated through the use of the annular barbs 320, 520, 620 described herein, threaded barbs, parts sorting (such as to counter tolerances), or any combination thereof.

In at least one embodiment, a valve can include a valve body having a port section and a coil support section extending along a longitudinal axis, a plunger within the valve body and extending at least partially through the coil support section, a poppet press-fit onto the plunger and configured to selectively open and close at least one flow path through the port section of the valve body, or any combination thereof. In at least one embodiment, the plunger can include a stem extending into the port section of the valve body. In at least one embodiment, the poppet can be press-fit onto the stem. In at least one embodiment, the stem can include one or more annular barbs to engage an interior of the poppet to hold the poppet in place on the stem. In at least one embodiment, the poppet can be configured to selectively engage a valve seat to selectively open and close the flow path through the port section of the valve body.

In at least one embodiment, the poppet can be rigid and/or configured to selectively engage a resilient valve seat to selectively open and close the flow path through the port section of the valve body. In at least one embodiment, the poppet can include a rigid portion configured to engage the barb on the stem and/or a resilient portion configured to selectively engage a valve seat to selectively open and close the flow path through the port section of the valve body. In at least one embodiment, the rigid portion can be harder than the resilient portion. In at least one embodiment, the rigid portion can include an annular flange. In at least one embodiment, the resilient portion can mate with the flange.

In at least one embodiment, the poppet can include a band around a perimeter of the poppet to secure the poppet to the stem. In at least one embodiment, the band can be crimped onto the poppet, thereby securing the poppet to the stem.

In at least one embodiment, the valve seat can be integral with the valve body. In at least one embodiment, the valve seat can be integral with a cap press-fit into one end of the valve body. In at least one embodiment, the poppet can include a seal configured to selectively engage a valve seat to selectively open and close the flow path through the port section of the valve body. In at least one embodiment, the poppet can include a first seal configured to selectively engage a first valve seat to selectively open and close a normally closed flow path through the port section of the valve body. In at least one embodiment, the poppet can include a second seal configured to selectively engage a second valve seat to selectively open and close a normally open flow path through the port section of the valve body.

In at least one embodiment, a valve can include a valve body having a port section and a coil support section extending along a longitudinal axis, a plunger within the valve body and extending at least partially through the coil support section, a poppet including a resilient portion configured to selectively engage a rigid valve seat to open and close at least one flow path through the port section of the valve body, or any combination thereof. In at least one embodiment, the plunger can include a stem extending into the port section of the valve body. In at least one embodiment, the stem can include at least one annular barb configured to engage an interior of the poppet to hold the poppet in place on the stem. In at least one embodiment, the valve seat can be integral with the valve body. In at least one embodiment, the valve seat can be integral with a cap press-fit into one end of the valve body.

In at least one embodiment, the poppet can include a rigid portion configured to engage the barb on the stem. In at least one embodiment, the rigid portion can be harder than the resilient portion. In at least one embodiment, the rigid portion can include an annular flange. In at least one embodiment, the resilient portion can mate with the flange.

In at least one embodiment, a valve can include a valve body having a port section and a coil support section extending along a longitudinal axis, a plunger within the valve body and extending at least partially through the coil support section, a poppet configured to selectively engage a valve seat to open and close a flow path through the port section of the valve body, or any combination thereof. In at least one embodiment, the plunger can include a stem extending into the port section of the valve body. In at least one embodiment, the stem can include a plurality of annular barbs. In at least one embodiment, the barbs can engage an interior of the poppet to hold the poppet in place on the stem.

Other and further embodiments utilizing one or more aspects of the disclosure can be devised without departing from the spirit of Applicants' disclosure. For example, the devices, systems and methods can be implemented for numerous different types and sizes in numerous different industries. Further, the various methods and embodiments of the devices, systems and methods can be included in combination with each other to produce variations of the disclosed methods and embodiments. Discussion of singular elements can include plural elements and vice versa. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the inventions has been described. Obvious modifications and alterations to the described embodiments are available to those of ordinary skill in the art having the benefits of the present disclosure. The disclosed and undisclosed embodiments are not intended to limit or restrict the scope or applicability of the inventions conceived of by the Applicants, but rather, in conformity with the patent laws, Applicants intend to fully protect all such modifications and improvements that come within the scope or range of equivalents of the following claims.

What is claimed is:

1. A valve comprising:
a valve body having a port section and a coil support section extending along a longitudinal axis;
a plunger within the valve body and extending at least partially through the coil support section; and
a poppet press-fit onto the plunger and configured to selectively open and close at least one flow path through the port section of the valve body.

2. The valve of claim 1, wherein the plunger includes a stem extending into the port section of the valve body; and wherein the poppet is press-fit onto the stem.

3. The valve of claim 2, wherein the stem includes an annular barb configured to engage an interior of the poppet to hold the poppet in place on the stem.

4. The valve of claim 2, wherein the stem includes a plurality of annular barbs configured to engage an interior of the poppet to hold the poppet in place on the stem.

5. The valve of claim 4, wherein the poppet includes a rigid portion configured to engage the barb on the stem and a resilient portion configured to selectively engage a valve seat to selectively open and close the flow path through the port section of the valve body; and wherein the rigid portion is harder than the resilient portion.

6. The valve of claim 5, wherein the rigid portion includes an annular flange; and wherein the resilient portion is configured to mate with the flange.

7. The valve of claim 2, further comprising a band around a perimeter of the poppet to secure the poppet to the stem.

8. The valve of claim 7, wherein the band is crimped onto the poppet, thereby securing the poppet to the stem.

9. The valve of claim 1, wherein the poppet is configured to selectively engage a valve seat to selectively open and close the flow path through the port section of the valve body.

10. The valve of claim 9, wherein the valve seat is integral with the valve body.

11. The valve of claim 9, wherein the valve seat is integral with a cap press-fit into one end of the valve body.

12. The valve of claim 1, wherein the poppet includes a seal configured to selectively engage a valve seat to selectively open and close the flow path through the port section of the valve body.

13. The valve of claim 1, wherein the poppet includes a first seal configured to selectively engage a first valve seat to selectively open and close a normally closed flow path through the port section of the valve body; and wherein the poppet includes a second seal configured to selectively engage a second valve seat to selectively open and close a normally open flow path through the port section of the valve body.

14. The valve of claim 1, wherein the poppet is rigid and is configured to selectively engage a resilient valve seat to selectively open and close the flow path through the port section of the valve body.

15. A valve comprising:
a valve body having a port section and a coil support section extending along a longitudinal axis;
a plunger within the valve body and extending at least partially through the coil support section, wherein the plunger includes a stem extending into the port section of the valve body; and
a poppet including a resilient portion configured to selectively engage a rigid valve seat to open and close at least one flow path through the port section of the valve body;
wherein the stem includes at least one annular barb configured to engage an interior of the poppet to hold the poppet in place on the stem.

16. The valve of claim 15, wherein the poppet comprises a rigid portion configured to engage the barb on the stem; and wherein the rigid portion is harder than the resilient portion.

17. The valve of claim 16, wherein the rigid portion includes an annular flange; and wherein the resilient portion is configured to mate with the flange.

18. The valve of claim 15, wherein the valve seat is integral with the valve body.

19. The valve of claim 15, wherein the valve seat is integral with a cap that is press-fit at least partially into one end of the valve body.

20. A valve comprising:
a valve body having a port section and a coil support section extending along a longitudinal axis;
a plunger within the valve body and extending at least partially through the coil support section, wherein the plunger includes a stem extending into the port section of the valve body, and wherein the stem includes a plurality of annular barbs; and
a poppet configured to selectively engage a valve seat to open and close a flow path through the port section of the valve body;
wherein the barbs are configured to engage an interior of the poppet to hold the poppet in place on the stem.
